(19) United States
(12) Patent Application Publication
(10) Pub. No.: US 2017/0343303 A1
(43) Pub. Date: Nov. 30, 2017

(54) PELLET COMPOSITIONS, KITS, AND METHODS FOR SEALING LEAKS

(71) Applicant: Prestone Products Corporation, Danbury, CT (US)

(72) Inventors: Thomas G. Kalagher, Torrington, CT (US); Joseph Mathews, New Milford, CT (US); Edward T. Turner, Danbury, CT (US)

(21) Appl. No.: 15/676,432

(22) Filed: Aug. 14, 2017

Related U.S. Application Data
(62) Division of application No. 14/847,349, filed on Sep. 8, 2015.
(60) Provisional application No. 62/047,398, filed on Sep. 8, 2014.
(60) Provisional application No. 62/150,546, filed on Apr. 21, 2015.

(51) Int. Cl. F28F 11/00; C09K 3/12

(52) U.S. Cl. CPC F28F 11/00; C09K 3/12; F01P 2031/00

(57) ABSTRACT

Pellet compositions for sealing a leak include (a) a fibrillated fibrous material, (b) a particulate material, and (c) a compound that by itself and/or in combination with at least one additional compound is configured to generate effervescence. Systems for sealing a leak include (a) a pellet composition, and (b) a first fluid configured for combination with the pellet composition, wherein the first fluid includes water. Methods for sealing a leak in a heat exchange system are described.

### RELATED APPLICATIONS

This is a divisional application of application Ser. No. 14/847,349, filed Sep. 8, 2015, which claims the benefit of U.S. Provisional Application No. 62/047,398, filed Sep. 8, 2014, and U.S. Provisional Application No. 62/150,546, filed Apr. 21, 2015. The entire contents of all three of these documents are incorporated herein by reference, except that in the event of any inconsistent disclosure or definition from the present specification, the disclosure or definition herein shall be deemed to prevail.

### TECHNICAL FIELD

The present teachings relate generally to sealing compositions and, in some embodiments, to sealing compositions for use with heat exchange systems.

### BACKGROUND

Stop leak products may be added to heat exchange systems (e.g., radiators, heater cores, etc.) to plug cracks and/or holes in the systems that cause the leakage of fluid.

### SUMMARY

The scope of the present invention is defined solely by the appended claims, and is not affected to any degree by the statements within this summary.

By way of introduction, a first pellet composition for sealing a leak in accordance with the present teachings includes (a) a fibrillated fibrous material, (b) a particulate material, and (c) a compound that by itself and/or in combination with at least one additional compound is configured to generate effervescence.

A second pellet composition for sealing a leak in accordance with the present teachings includes (a) a fibrillated fibrous material containing an aramid fiber; (b) a particulate material containing a seed meal and a mineral-based material; (c) two or more compounds configured to chemically react with one another to generate gaseous CO₂; and (d) a lubricant.

A first method for sealing a leak in a heat exchange system in accordance with the present teachings includes introducing a pellet composition of a type described above into the heat exchange system.

A kit for sealing a leak in accordance with the present teachings includes (a) a pellet composition of a type described above, and (b) a first fluid configured for combination with the pellet composition. The first fluid includes water.

A second method for sealing a leak in a heat exchange system in accordance with the present teachings includes (a) combining a pellet composition of a type described above and at least one fluid to form a mixture; and (b) introducing the mixture into the heat exchange system. The at least one fluid includes water.

### DETAILED DESCRIPTION

Sealing compositions with a capacity for sealing one or more leaks in a heat exchange system—including but not limited to automotive heat exchange systems (e.g., radiators and/or heater cores, engine blocks, head gaskets, etc.) and residential/nonresidential heat exchange systems (e.g., space heating, refrigeration, air conditioning, solar panels, power plants, chemical plants, petrochemical plants, petroleum refineries, natural gas processing, sewage treatment, etc.)—have been discovered and are described herein. In some embodiments, as further described below, sealing compositions in accordance with the present teachings are provided as effervescent pellet compositions. The effervescent pellet compositions may be combined with one or more fluids prior to, or substantially contemporaneously with, their introduction to a heat exchange system.

Conventional sealer pellet compositions (e.g., “stop leak”) may not break apart easily or rapidly when introduced into a heat exchange system, thereby reducing their efficacy, prolonging the amount of time required for their dissolution and/or dispersal throughout the heat exchange system and, in some cases, preventing the constituents of the compositions from ever reaching the site of a leak. In contrast to conventional pellets, the effervescent pellet compositions in accordance with the present teachings provide improved (e.g., more rapid and/or more thorough) dispersal of constituents of the sealing composition through a heat exchange system. As a result of this improved delivery, the fibrillated fibers of the sealing compositions may quickly begin to patch holes, and the particulate material (and optional thickening agents) may more quickly fill in the patched holes, cracks, pits, gouges, and/or the like in the heat exchange system as compared to conventional sealer pellet compositions.

While neither desiring to be bound by any particular theory nor intending to limit in any measure the scope of the appended claims or their equivalents, it is presently believed that the generation of gas by an effervescent pellet composition in accordance with the present teachings provides an agitative and/or propulsive effect in a liquid, which may contribute to the ability of one or more constituents of the pellet composition to diffuse through a heat exchange system, and increase the likelihood of one or more constituents of the composition from reaching a hole or crack (e.g., the cause of a leak) in a heat exchange system.

It is to be understood that elements and features of the various representative embodiments described below may be combined in different ways to produce new embodiments that likewise fall within the scope of the present teachings.

By way of general introduction, a first pellet composition for sealing a leak in accordance with the present teachings includes a fibrillated fibrous material, a particulate material, and a compound that by itself and/or in combination with at least one additional compound is configured to generate effervescence.

As used herein, the phrase “fibrillated fibrous material” refers to fibers having branching and/or a roughened surface and/or one or more deformations and/or one or more irregularities (e.g., as opposed to smooth and round fibers) configured for increasing bonding characteristics of the fibers. One method that may be used to quantify relative degree of fibrillation in a material is the Canadian Standard Freeness (CSF) test described in TAPPI Official Test Method document T227 om-99 (Revised 1999) entitled “Freeness of pulp (Canadian standard method).” The entire contents of TAPPI Official Test Method document T227 om-99 are incorporated herein by reference, except that in the event of any inconsistent disclosure or definition from the present specification, the disclosure or definition herein shall be deemed to prevail.

Fibrillated fibrous materials may be provided in an amount and of a size sufficient to become entrained in and seal at least one leak (e.g., in a heat exchange system). All manner of fibrillated fibers are contemplated for use in accordance with the present teachings. By way of example, in some embodiments, a fibrillated fibrous material includes a poly-paraphenylene terephthalamide pulp. Representative types of poly-paraphenylene terephthalamide pulp include but are not limited to aramid fibers, including but not limited to the aramid fibers sold under the trade names KEVLAR® (DuPont Advanced Fibers Systems, Richmond, Va.) and SPECTRA® (Honeywell, Colonial Heights, Va.). In some embodiments, a fibrillated fibrous material includes an aramid fiber selected from the group consisting of 1F361 KEVLAR® wet pulp (about 50% moisture, 1.05 mm length, 140 CSF), 1F538 KEVLAR® dry pulp (about 7% moisture, 1.17 mm length, 260 CSF), 1F543 KEVLAR® dry pulp (about 7% moisture, 1.05 mm length, 140 CSF), and combinations thereof. In some embodiments, a fibrillated fibrous material includes a plant-based fiber (e.g., cotton fiber, hemp fiber, cellulose fiber, linen fiber, and/or the like, and combinations thereof. In other embodiments, a fibrillated fibrous material includes a mineral-based material (e.g., asbestos, etc.). In further embodiments, a fibrillated fibrous material includes a carbon fiber, fiberglass, a polyamide (e.g., nylons including but not limited to nylon 6,6), and/or the like, and combinations thereof.

The amount of fibrillated fibrous material provided in a pellet composition in accordance with the present teachings may be varied depending on the particular application. In some embodiments, the fibrillated fibrous material comprises from about 0.3 weight percent to about 10 weight percent of the pellet composition. In other embodiments, the fibrillated fibrous material comprises from about 0.3 weight percent to about 2 weight percent of the pellet composition.

In some embodiments, the fibrillated fibrous material includes poly-paraphenylene terephthalamide. In some embodiments, a pellet composition includes from about 0.3 to about 10 weight percent of a poly-paraphenylene terephthalamide fiber (e.g., SPECTRA® and/or KEVLAR®). The amount of a poly-paraphenylene terephthalamide fiber may be one of several different values or fall within one of several different ranges. It is within the scope of the present disclosure to select an amount of a fibrillated fibrous material to be one of the following values: about 0.3%, 0.5%, 1%, 2%, 3%, 4%, 5%, 6%, 7%, 7.5%, 8%, 9%, or 10% of the pellet composition by weight percentage. It is likewise within the scope of the present disclosure for the amount of a poly-paraphenylene terephthalamide fiber in the pellet composition to fall within one of many different ranges. In a first set of ranges, the range of a poly-paraphenylene terephthalamide fiber is one of the following ranges: about 0.3% to 10%, 0.5% to 10%, 1% to 10%, 2% to 10%, 3% to 10%, 4% to 10%, 5% to 10%, 6% to 10%, 7% to 10%, 8% to 10%, and 9% to 10% of the pellet composition by weight percentage. In a second set of ranges, the range of a poly-paraphenylene terephthalamide fiber is one of the following ranges: about 0.3% to 9%, 0.3% to 8%, 0.3% to 7%, 0.3% to 6%, 0.3% to 5%, 0.3% to 4%, 0.3% to 3%, 0.3% to 2%, 0.3% to 1%, and 0.3% to 0.5% of the pellet composition by weight percentage. In a third set of ranges, the range of a poly-paraphenylene terephthalamide fiber is one of the following ranges: about 5% to 9%, 5% to 8%, 6% to 9%, 6% to 8%, 7% to 9%, and 5% to 8% of the pellet composition by weight percentage. In alternative embodiments (e.g., a kit in accordance with the present teachings, as further described below), all or a portion of the fibrillated fibrous material may be provided in one or more fluids that are to be later combined with the pellet composition as opposed to, or in addition to, being provided in the pellet composition itself. In some embodiments, the fibrillated fibrous material may be suspended within one or more liquid portions that are to be combined with the pellet composition.

As used herein, the phrase “particulate material” refers to any material containing particles (or any combination of such materials) that—when used in a pellet composition and/or a method in accordance with the present teachings—is configured to become entrained in a leak-causing crack and/or hole.

Particulate materials may be provided in an amount and of a size sufficient to become entrained in and seal at least one leak (e.g., in a heat exchange system). All manner of particulate materials are contemplated for use in accordance with the present teachings. By way of example, in some embodiments, a particulate material includes a seed meal, ground root, cellulosic materials (e.g. wood pulp), mineral-based materials (e.g., a clay and/or a clay analog), soda ash, an acrylic copolymer, enzyme-based thickening agents (e.g., dextrins), titanium dioxide, and/or the like, and combinations thereof. In some embodiments, the particulate material for use in accordance with the present teachings includes a seed meal. Representative types of seed meal for use in accordance with the present teachings include but are not limited to soybean meal, corn meal, wheat germ, linseed meal, jojoba bean meal, and/or the like, and combinations thereof. In some embodiments, the seed meal includes soybean meal.

In some embodiments, the particulate material includes a mineral-based material (e.g., a clay and/or a clay analog). Representative clay and clay analogs for use in accordance with the present teachings include but are not limited to bentonite, smectite, montmorillonite, paligorskite, attapulgite, sepiolite, saponite, kaolinite, halloysite, hectorite, beidellite, stevensite, fire clay, ground shale, mud, silt, and/or the like, and combinations thereof. In some embodiments, the particulate material includes diatomaceuous earth. In other embodiments, the particulate material includes bentonite and/or attapulgite.

In some embodiments, the particulate material includes a combination of two or more mineral-based materials. Representative mineral-based materials that may be used in such a combination include but are not limited to bentonite and attapulgite. In some embodiments, the attapulgite clay sold under the trade name ATTACLAY® (Engelhard Corp., Iselin, N.J.) may be used. In some embodiments, the bentonite clay sold under the trade name KWK Bentonite (American Colloid Company, Arlington Heights, Ill.), which may act as both a suspending and a thickening agent, may be used. In some embodiments, a pellet composition in accordance with the present teachings includes bentonite and attapulgite. In some embodiments, the particulate material includes a combination of two or more mineral-based materials (e.g., attapulgite and bentonite) and a seed meal (e.g., soybean meal).

The amount of particulate material provided in a pellet composition in accordance with the present teachings may be varied depending on the particular application. In some embodiments, the particulate material comprises up to about 95 weight percent of the pellet composition. In some embodiments, the particulate material comprises up to about 55 weight percent of the pellet composition. In other embodiments, the particulate material comprises from about 5 weight percent to about 15 weight percent of the pellet composition. The amount of particulate material may be one of several different values or fall within one of several different ranges. It is within the scope of the present disclosure to select an amount of particulate material to be one of the following values: about 0%, 1%, 5%, 6%, 7%, 7.5%, 8%, 9%, 10%, 11%, 12%, 13%, 14%, 15%, 20%, 25%, 30%, 35%, 40%, 45%, 46%, 47%, 48%, 49%, 50%, 51%, 52%, 53%, 54%, 55%, 60%, 65%, 70%, 75%, 80%, 85%, 90%, or 95% of the pellet composition by weight percentage. It is likewise within the scope of the present disclosure for the amount of a particulate material in the pellet composition to fall within one of many different ranges. In a first set of ranges, the range of a particulate material is one of the following ranges: about 0% to 95%, 1% to 95%, 5% to 95%, 10% to 95%, 15% to 95%, 20% to 95%, 25% to 95%, 30% to 95%, 35% to 95%, 40% to 95%, 45% to 95%, 50% to 95%, 55% to 95%, 60% to 95%, 65% to 95%, 70% to 95%, 75% to 95%, and 80% to 95% of the pellet composition by weight percentage. In a second set of ranges, the range of a particulate material is one of the following ranges: about 0% to 90%, 0% to 85%, 0% to 80%, 0% to 70%, 0% to 60%, 0% to 55%, 0% to 50%, 0% to 45%, 0% to 40%, 0% to 30%, 0% to 20%, 0% to 15%, 0% to 14%, 0% to 13%, 0% to 12%, 0% to 11%, 0% to 10%, 0% to 9%, 0% to 8%, 0% to 7%, 0% to 6%, and 0% to 5% of the pellet composition by weight percentage. In a third set of ranges, the range of a particulate material is one of the following ranges: about 40% to 60%, 45% to 60%, 50% to 60%, 50% to 55%, 45% to 55%, 40% to 55%, 45% to 50%, 46% to 55%, 47% to 55%, 48% to 55%, and 49% to 55% of the pellet composition by weight percentage. In a fourth set of ranges, the range of a particulate material is one of the following ranges: about 5% to 15%, 5% to 14%, 5% to 13%, 5% to 12%, 5% to 11%, 5% to 10%, 10% to 15%, 10% to 14%, 10% to 13%, 10% to 12%, and 10% to 11% of the pellet composition by weight percentage. In some embodiments, a pellet composition lacks a particulate material.

As used herein, the term “effervescence” refers to gas bubbles (e.g., gas bubbles in a liquid). All manner of compounds that are configured to generate effervescence—either by themselves and/or in combination with one or more additional compounds—are contemplated for use in accordance with the present teachings. In some embodiments, the effervescence includes gaseous CO₂, gaseous N₂, or a combination thereof. In some embodiments, the compound is configured to generate effervescence by itself (e.g., a unimolecular reaction, such as an azide compound that decomposes to release N₂ gas). In other embodiments, the compound is configured to generate effervescence through a chemical reaction with at least one additional compound (e.g., a bimolecular, trimolecular, or higher-order reaction).

In some embodiments, the pellet composition includes all of the reactants needed to generate effervescence (e.g., a first compound as well as at least one additional compound). In other embodiments, the pellet composition contains less than all of the reactants needed to generate effervescence. By way of example, one or more of the compounds may be provided in a liquid that is later to be combined with the pellet composition (e.g., prior to or contemporaneously with the introduction of the composition to a heat exchange system).

For embodiments in which the pellet composition contains less than all of the compounds needed to generate effervescence, and one or more fluids that are to later be combined with the pellet composition contains the remainder of the compounds needed to generate effervescence, it may be desirable to combine and mix the pellet composition and the one or more fluids prior to introducing the components into the heat exchange system. In a bimolecular reaction (e.g., first reactant A and second reactant B undergoing a chemical reaction to produce first product C and second product D), the rate of the reaction is proportional to the rate at which the reactants A and B come together. Thus, the rate of the reaction may be higher if the pellet composition (e.g., which contains reactant A) and the liquid (e.g., which contains reactant B) are mixed prior to introducing the pellet composition and the liquid into the heat exchange system. Once inside the heat exchange system, the concentrations of the reactants A and B may be expected to decrease due to the effects of dilution.

In some embodiments, a pellet composition for sealing a leak in accordance with the present teachings includes a compound that is configured to generate effervescence by itself. In other embodiments, a pellet composition for sealing a leak in accordance with the present teachings includes a compound that is configured to generate effervescence in combination with at least one additional compound. In some embodiments, the pellet composition further includes the at least one additional compound. In other embodiments, the at least one additional compound is provided separately from the pellet composition (e.g., in a fluid). In some embodiments, the compound includes an acid and the at least one additional compound includes a base. In some embodiments, the acid includes a Brønsted-Lowry acid, and the base includes a Brønsted-Lowry base.

Representative Brønsted-Lowry acids for use in accordance with the present teachings include but are not limited to malic acid, citric acid, tartaric acid, adipic acid, acetic acid, and/or the like, and combinations thereof. Representative Brønsted-Lowry bases for use in accordance with the present teachings include but are not limited to carbonates (e.g., Na₂CO₃, K₂CO₃, etc.), bicarbonates (e.g., NaHCO₃, KHCO₃, etc.), and/or the like, and combinations thereof. In some embodiments, the acid includes citric acid and the base includes a bicarbonate (e.g., NaHCO₃). In such embodiments, the effervescence generated by the acid-base reaction includes CO₂ gas.

Citric acid and sodium bicarbonate may react to generate carbon dioxide gas as shown by the following equation:

C₆H₈O_{(aq)}+3NaHCO_{3(aq)}→3H₂O₍₁₎+3CO_{2(g)}+Na₃C₆H₅O_{7(aq)}

Although citric acid and sodium bicarbonate provide one example of a binary effervescence-generating system, other combinations of compounds that may come together to generate effervescence—including but not limited to tertiary systems (e.g., three reactants) or higher-order systems (e.g., four or more reactants, etc.)—may likewise be used.

In some embodiments, pellet compositions in accordance with the present teachings may further include a lubricant. All manner of lubricants, and combinations thereof, are contemplated for use in accordance with the present teachings. By way of example, in some embodiments, a lubricant includes a plant-derived oil (e.g., a vegetable-based oil). Representative types of plant-derived oils that may be used in accordance with the present teachings include but are not limited to palm oil, sunflower seed oil, rapeseed oil, cottonseed oil, soybean oil, coconut oil, corn oil, olive oil, peanut oil, safflower oil, sesame oil, and/or the like, and combinations thereof. In some embodiments, the lubricant includes soybean oil.

In some embodiments, a lubricant may include a plant-derived lecithin. In some embodiments, a lubricant includes both a plant-derived oil and a plant-derived lecithin. Representative types of plant-derived lecithins that may be used in accordance with the present teachings include but are not limited to palm lecithin, sunflower seed lecithin, rapeseed lecithin, cottonseed lecithin, soybean lecithin, coconut lecithin, corn lecithin, olive lecithin, peanut lecithin, safflower lecithin, sesame lecithin, and/or the like, and combinations thereof. In some embodiments, a lubricant for use in accordance with the present teachings includes a combination of soybean oil and soybean lecithin.

The amount of lubricant provided in a pellet composition in accordance with the present teachings may be varied depending on the particular application. In some embodiments, the lubricant comprises up to about 8 weight percent of the pellet composition. In other embodiments, at least one lubricating oil comprises from about 1 to 5 weight percent of the pellet composition. The amount of the lubricant may be one of several different values or fall within one of several different ranges. It is within the scope of the present disclosure to select an amount of at least one lubricating oil to be one of the following values: about 0%, 1%, 2%, 3%, 4%, or 5% of the pellet composition by weight percentage. It is likewise within the scope of the present disclosure for the amount of lubricant in the pellet composition to fall within one of many different ranges, including but not limited to about 0% to 5%, 1% to 5%, 2% to 5%, 3% to 5%, 4% to 5%, 1% to 4%, 2% to 4%, 3% to 4%, 2% to 3%, and 1% to 3% of the pellet composition by weight percentage. In some embodiments, a pellet composition is free of lubricating oil.

In some embodiments, a pellet composition in accordance with the present teachings further includes one or more additional additives, including but not limited to processing aids, biocides, preservatives, dyes, and/or the like, and combinations thereof. By way of example, a pellet composition may include an insect repellent to repel bugs (e.g., insects and non-insects, such as bacteria) or at least to deter bugs from eating the pellet composition. Representative types of additional additives that may be added to pellet compositions in accordance with the present teaching include but are not limited to preservatives (e.g., calcium propionate). In some embodiments, a pellet composition includes 0 to 5 weight percent of a preservative. The amount of a preservative may be one of several different values or fall within one of several different ranges. It is within the scope of the present disclosure to select an amount of preservative to be one of the following values: about 0%, 1%, 2%, 3%, 4%, or 5% of the pellet composition by weight percentage. It is likewise within the scope of the present disclosure for the amount of a preservative in the pellet composition to fall within one of many different ranges, including about 0% to 5%, 1% to 5%, 2% to 5%, 3% to 5%, 4% to 5%, 1% to 4%, 2% to 4%, 3% to 4%, 2% to 3%, and 1% to 3% of the pellet composition by weight percentage. In some embodiments, a pellet composition lacks a preservative.

A second pellet composition for sealing a leak in accordance with the present teachings includes (a) a fibrillated fibrous material containing an aramid fiber; (b) a particulate material containing a seed meal and a mineral-based material; (c) two or more compounds configured to chemically react with one another to generate gaseous CO₂; and (d) a lubricant. In some embodiments, the fibrillated fibrous material comprises from about 0.3 weight percent to about 2 weight percent of the pellet composition. In some embodiments, the particulate material comprises up to about 85 weight percent of the pellet composition. In some embodiments, the lubricant comprises up to about 8 weight percent of the pellet composition.

The shape and dimensions of a pellet in accordance with the present teachings may vary depending on the particular application and the specifications of the pellet press used for pressing the pellets. By way of example, for pellet compositions that are to be introduced to a heat exchange system via pouring (e.g., into an automotive radiator), the length of the pellets may have an effect on their pourability (e.g., pourability may decrease with increasing length). In some embodiments, a pellet composition in accordance with the present teachings is provided as a pellet having a diameter of between about 4 mm and about 8 mm, and a length of between about 4 mm and about 25 mm.

The total weight of a pellet prepared in accordance with the present teachings may be one of several different values or fall within one of several different ranges. For example, it is within the scope of the present disclosure to select a total weight of a pellet composition to be one of the following values: about 20, 25, 30, 35, 40, 45, 50, 55, 60, 65, 70, 75, 80, 85, 90, 95, 100, 105, 110, 115, 120, 125, 130, 135, 140, 145, or 150 grams. It is likewise within the scope of the present disclosure for the total weight of the pellet composition to fall within one of many different ranges. In a first set of ranges, the range of the total weight of the pellet composition is one of the following ranges: about 20 to 150, 30 to 150, 40 to 150, 45 to 150, 50 to 150, 55 to 150, 60 to 150, 70 to 150, 80 to 150, 90 to 150, 100 to 150, 120 to 150, or 125 to 150 grams. In a second set of ranges, the range of the total weight of the pellet composition is one of the following ranges: about 20 to 125, 20 to 150, 20 to 95, 20 to 90, 20 5o 85, 20 to 80 20 to 75, 20 to 70, 20 to 65, 20 to 60, 20 to 55, 20 to 50, 20 to 45, and 20 to 40 grams. In a third set of ranges, the total weight of the pellet composition is one of the following ranges: about 40 to 60, 45 to 60, 50 to 60, 50 to 55, 45 to 55, 40 to 55, 45 to 50, 46 to 55, 47 to 55, 48 to 55, and 49 to 55 grams.

In some embodiments, a pellet composition in accordance with the present teachings is provided as a pellet weighing from about 20 to 150 grams. In other embodiments, a pellet composition in accordance with the present teachings is provided as a pellet weighing from about 30 to 120 grams. In further embodiments, a pellet composition in accordance with the present teachings is provided as a pellet weighing from about 40 to 80 grams.

While the actual amount (e.g., x grams) of a given component (e.g., fibrillated fibrous material) being introduced to a heat exchange system via pellet composition may be the same for two different pellets, the weight percentage of the component in the respective pellets may be higher or lower depending on the total weight of the particular pellet. For example, in some embodiments, a pellet may include a carrier (e.g., an inactive solid) that acts as a diluent, thereby increasing the total weight of the pellet composition and, in turn, decreasing the weight percentage of a given component thereof. In other embodiments, a pellet may lack such a carrier (or contain a lesser amount of such a carrier).

In some embodiments, the specific weight percentages and ranges of weight percentages recited herein for individual components of a pellet composition are to be understood in relation to a pellet having a total weight that ranges from about 20 to 150 grams. In other embodiments, the specific weight percentages and ranges of weight percentages recited herein for individual components of a pellet composition are to be understood in relation to a pellet having a total weight that ranges from about 30 to 120 grams. In further embodiments, the specific weight percentages and ranges of weight percentages recited herein for individual components of a pellet composition are to be understood in relation to a pellet having a total weight that ranges from about 40 to 80 grams. By way of example, a pellet composition described herein as containing “10 weight percent of a fibrillated fibrous material” includes about 7.5 grams of the fibrillated fibrous material when the pellet weighs a total of about 75 grams, and about 12.5 grams of the fibrillated fibrous material when the pellet weighs a total of about 125 grams.

A pellet composition in accordance with the present teachings may be combined with one or more additional components (e.g., fluid components and/or other solid components) either prior to or substantially contemporaneously with the introduction of the pellet composition to a heat exchange system. The one or more fluids may include one or a plurality of additional components that provide a desired benefit—by themselves and/or in combination with one or more components of the pellet composition—vis-á-vis sealing a leak. The combination of a pellet composition and one or more separate components (e.g., fluids) that are to be combined with the pellet composition is referred to as a “kit.” The order of combination of the respective components of a kit in accordance with the present teachings may be varied depending on a particular application. In some embodiments, all of the components are combined prior to introduction of the pellet composition to a heat exchange system. In other embodiments, the components or added sequentially to the heat exchange system in any order.

As used herein, the term “kit” refers to an assembly of materials that are used in performing a method in accordance with the present teachings. The components of the kit may be provided in packaged combination in the same or in separate containers, depending on their cross-reactivities and stabilities, and in liquid or in solid form. The amounts and proportions of components provided in the kit may be selected so as to provide optimum results for a particular application. While in some embodiments, the components to be introduced to a heat exchange system may be provided in separate physical forms (e.g., a kit containing one or more pellet compositions and one or more fluids), it is to be understood that in other embodiments, all of the components that are to be introduced to a heat exchange system may be provided together in one common physical form (e.g., one pellet composition or one fluid).

The components included in kits in accordance with the present teachings may be supplied in all manner of containers such that the activities of the different components are substantially preserved, while the components themselves are not substantially adsorbed or altered by the materials of the container. Suitable containers include but are not limited to ampoules, bottles, test tubes, vials, flasks, syringes, bags and envelopes (e.g., foil-lined), and the like. The containers may be formed of any suitable material including but not limited to glass, organic polymers (e.g., polycarbonate, polystyrene, polyethylene, polypropylene, etc.), ceramic, metal (e.g., aluminum), metal alloys (e.g., steel), cork, and the like. In addition, the containers may contain one or more access ports (e.g., for access via a needle), such as may be provided by a septum. Preferred materials for septa include rubber and polymers including but not limited to, for example, polytetrafluoroethylene of the type sold under the trade name TEFLON by DuPont (Wilmington, Del.). In addition, the containers may contain two or more compartments separated by partitions or membranes that can be removed to allow mixing of the components.

Kits in accordance with the present teachings may also be supplied with other items known in the art and/or which may be desirable from a commercial and user standpoint, including but not limited to instructions for adding the components of the kit to a heat exchange system.

Instructional materials provided with kits in accordance with the present invention may be printed (e.g., on paper) and/or supplied in an electronic-readable medium (e.g., floppy disc, CD-ROM, DVD-ROM, zip disc, videotape, audio tape, etc.). Alternatively, instructions may be provided by directing a user to an Internet web site (e.g., specified by the manufacturer or distributor of the kit) and/or via electronic mail, text message, social media, and/or the like, and combinations thereof.

In some embodiments, a pellet composition in accordance with the present teachings may be added in solid pellet form to a heat exchange system. Such embodiments may be suitable for sealing leaks in lower temperature applications, including but not limited to radiators and/or heater cores. In some embodiments, a kit for sealing a leak in accordance with the present teachings includes a pellet composition of a type described herein and at least a first fluid configured for combination with the pellet composition. In some embodiments, the first fluid includes water.

In some embodiments, a pellet composition may be combined with one or more additional components (e.g., fluids) either prior to or substantially contemporaneously with the introduction of the pellet composition to a heat exchange system. In some embodiments—for example, higher temperature applications including but not limited to engine blocks and head gaskets—the first fluid to be combined with the pellet composition may further include sodium silicate (which, in other embodiments, may be provided in the pellet composition itself instead of, or in addition to, in the first fluid). While neither desiring to be bound by any particular theory nor intending to limit in any measure the scope of the appended claims or their equivalents, it is presently believed that the use of sodium silicate in combination with a pellet composition in accordance with the present teachings may serve to increases the efficacy of repairing a leak at higher temperatures and/or pressures (e.g., engine blocks, head gaskets, etc.). Furthermore, while neither desiring to be bound by any particular theory nor intending to limit in any measure the scope of the appended claims or their equivalents, it is presently believed that large amounts of sodium silicate may hinder leak stoppage in lower-temperature applications (e.g., in radiators and heater cores) possibly due to the sodium silicate acting as a lubricant. Thus, in some embodiments, sodium silicate is not used in the repair of holes or cracks in radiators and/or heater cores.

In some embodiments, as further described below, sodium silicate may be provided in one or more fluids that are to be combined with the pellet composition. In some embodiments, the first fluid further includes sodium silicate. The amount of sodium silicate provided in a first fluid in accordance with the present teachings may be varied depending on the particular application (e.g., engine block, head gasket, etc.). By way of non-limiting example, the amount of sodium silicate provided in a first fluid used for sealing a leak in an engine block may be up to about 100 grams (e.g., a “low amount”). Similarly, by way of further non-limiting example, the amount of sodium silicate provided in a first fluid used for sealing a leak in a head gasket may be between about 100 grams and 400 grams (e.g., a “high amount”).

In some embodiments, the sodium silicate comprises from about 3 weight percent to about 10 weight percent of the first fluid (e.g., a range which, as used herein, refers to a “low amount” of sodium silicate). In some embodiments, the sodium silicate comprises from about 3.5 weight percent to about 6 weight percent of the first fluid, and the kit is configured for sealing a leak in an engine block.

In some embodiments, the sodium silicate comprises from about 25 weight percent to about 50 weight percent of the first fluid (e.g., a range that as used herein refers to a “high amount” of sodium silicate). In some embodiments, the sodium silicate comprises from about 30 weight percent to about 45 weight percent of the first fluid, and the kit is configured for sealing a leak in a head gasket.

In some embodiments, the first fluid lacks sodium silicate, and the kit is configured for sealing a leak in a radiator and/or a heater core.

In some embodiments, a kit in accordance with the present teachings further includes at least a second fluid. The second fluid is configured for combination with the pellet composition and the first fluid (e.g., prior to and/or substantially contemporaneously with the introduction of the pellet composition and the first fluid to a heat exchange system). In some embodiments, the second fluid includes water. In some embodiments, the second fluid further includes one or more additional additives, including but not limited to soda ash, thickeners, base (e.g., sodium hydroxide) to adjust pH if an acid (e.g., citric acid) was used to generate effervescence, biocides, antifoaming agents, cellulosic polymers, copper powder, dyes, and/or the like, and combinations thereof.

In some embodiments, the second fluid includes a thickener. Representative thickeners for use in the second fluid include but are not limited to polymers (e.g., cellulosic polymers), and one or more of the particulate materials described above in connection with the pellet composition (e.g., seed meal, ground root, cellulosic materials, mineral-based materials, soda ash, acrylic copolymers, enzyme-based thickening agents, and/or the like, and combinations thereof). In some embodiments, the thickener includes an acrylic hardener. Representative thickeners for use in the second fluid include but are not limited to polyacrylamide, methyl methacrylate, poly(methyl methacrylate), methacrylate, ethyl acrylate, butyl acrylate, ethyl acrylate, and/or the like, and combinations thereof. In some embodiments, the second fluid includes an anionic thickener, including but not limited to the anionic thickener sold under the trade name Acrysol™ ASE-60 (Dow Chemical Company). Such a thickener may be used to harden the seal formed on a hole or crack, thereby increasing its durability. Thus, the ASE-60 may be used as both a thickener and a hardener.

In some embodiments, the second fluid includes a cellulosic thickener. Representative cellulosic thickeners for use in the second fluid include but are not limited to cellulose macromolecules (e.g., sulfonates), vegetable gums (e.g., xanthan gum, alginin, guar gum, locust bean gum), castor oil and derivatives thereof, and/or the like, and combinations thereof. In some embodiments, the cellulosic thickener includes a medium-low molecular weight cellulosic polymer, such as that sold under the trade name Sellosize™ QP5200H (Dow).

The amount of thickener (e.g., acrylic copolymer) provided in a second fluid in accordance with the present teachings may be varied depending on the particular applications. In some embodiments, the thickener may be present in the second fluid in an amount up to about 5 weight percent of the second fluid. In other embodiments, the thickener (e.g., acrylic hardener) may be present in the second fluid in an amount from about 1 to 3 weight percent of the second fluid. In some embodiments, the second fluid to be mixed with an effervescent sealer pellet composition in accordance with the present teachings may be one of several different values or fall within one of several different ranges. In a first set of ranges, the range of a thickener is one of the following: about 0% to 2%, 0% to 1%, 1% to 2%, and 0.5% to 2% of the second fluid by weight percentage. In some embodiments, the second fluid lacks a thickener.

In some embodiments, the second fluid includes soda ash. In some embodiments, the soda ash comprises from about 0 to 1 weight percent of the second fluid. In other embodiments, the second fluid lacks soda ash. In some embodiments, the second fluid lacks soda ash and the pellet composition includes soda ash. In other embodiments, each of the second fluid and the pellet composition includes soda ash.

In some embodiments, the second fluid includes an antifoaming agent. Representative antifoaming agents for use in accordance with the present teachings include but are not limited to the antifoaming agents sold under the trade names Foam Ban 2529C, PM5150, Defoamer DC-7, Defoamer 96, PC-5425, PATCOTE 415, SUPPRESSOR 1745, SUPPRESSOR 1723, SUPPRESSOR 2183, SUPPRESSOR 4625, and/or the like, and combinations thereof (Prestone Products Corporation, Danbury, Conn.; Hydrite Chemical Co., Brookfield, Wis.). In some embodiments, the amount of antifoaming agent may be one of several different values or fall within one of several different ranges. In a first set of ranges, the range of an antifoaming agent is one of the following: about 0% to 2%, 0% to 1%, 1% to 2%, and 0.5% to 2% of the second fluid by weight percentage. In some embodiments, the second fluid lacks an antifoaming agent.

The actual amount (e.g., x grams) of a given component (e.g., sodium silicate) being introduced to a heat exchange system via a fluid (e.g., a first fluid and/or a second fluid) may remain unchanged even though the weight percentage of the component in the fluid varies based on the total weight of the fluid. For example, as the amount of carrier (e.g., water) increases, the total weight of the fluid increases and, in turn, the weight percentage of any given component in the fluid decreases. In some embodiments, the specific weight percentages and ranges of weight percentages recited herein for individual components of a fluid are to be understood in relation to a fluid having a volume ranging from about 10 to 32 fluid ounces.

In some embodiments, as described above, a pellet composition may be combined with one or more fluids (e.g., a first fluid and a second fluid) either prior to or substantially contemporaneously with the introduction of the pellet composition to a heat exchange system. However, it is to be understood that in other embodiments, the components to be introduced to a heat exchange system need not be separated in such a manner. Rather, in some embodiments, the above-described components provided, respectively, in the first fluid and the second fluid may instead be provided in one common fluid. Moreover, in still further embodiments, all of the respective components may be provided in the pellet composition itself, such that neither a first fluid nor a second fluid is used.

In accordance with the present teachings, a common pellet composition may be used for multiple applications (e.g., radiator and/or heater core, engine block, head gasket, etc.), thereby providing ease of manufacturing and flexibility of usage. Differentiation to address the specifications called for by a particular application (e.g., whether sodium silicate is to be present and, if so, whether it is to be present in a “low amount” or a “high amount”) may be controlled through one or more fluid components provided in a kit in accordance with the present teachings.

In some embodiments, as described above, the present teachings provide compositions and kits for sealing a leak. In other embodiments, as further described below, the present teachings also provide methods for sealing a leak.

A first method for sealing a leak in a heat exchange system in accordance with the present teachings includes introducing a pellet composition into the heat exchange system. The pellet composition includes a fibrillated fibrous material, a particulate material, and a compound that by itself and/or in combination with at least one additional compound is configured to generate effervescence.

In some embodiments, the introducing includes adding the pellet composition to an overflow tank of the heat exchange system. In some embodiments, the heat exchange system includes a radiator and/or a heater core. In some embodiments, the heat exchange system includes a radiator, and the introducing includes adding the pellet composition directly to the radiator. In other embodiments, the heat exchange system includes a radiator, and the introducing includes adding the pellet composition to the radiator via an overfill tank. In other embodiments, the heat exchange system includes a radiator, and the introducing includes adding the pellet composition to the radiator via a surge tank. As described above, embodiments in which a pellet composition in accordance with the present teachings is added in solid pellet form to a heat exchange system—either directly or via an overflow tank coupled with the heat exchange system—may be used, for example, in sealing leaks in lower temperature applications, including but not limited to radiators and/or heater cores. For limited access systems, a hose (e.g., upper radiator hose) may be removed and the material may be added to the system through the hose prior to reconnecting the hose.

In some embodiments, methods in accordance with the present teachings include combining a pellet composition with one or more additional components (e.g., fluids) prior to or substantially contemporaneously with the introduction of the pellet composition to a heat exchange system. For embodiments in which a pellet composition is combined with a first fluid and/or a second fluid, mixing the pellet composition with one or more fluids may start the effervescent reaction. As described above, embodiments in which a pellet composition in accordance with the present teachings either includes sodium silicate or is combined with a first fluid and/or a second fluid that includes sodium silicate may be used, for example, in sealing leaks in higher temperature applications, including but not limited to engine blocks and head gaskets.

A second method for sealing a leak in a heat exchange system in accordance with the present teachings includes (a) combining a pellet composition and at least one fluid to form a mixture; and (b) introducing the mixture into the heat exchange system. The pellet composition includes a fibrillated fibrous material, a particulate material, and a compound that by itself and/or in combination with at least one additional compound is configured to generate effervescence. The at least one fluid includes water.

In some embodiments, the combining of the pellet composition and the at least one fluid occurs prior to the introducing. In some embodiments, the at least one fluid lacks sodium silicate, and the heat exchange system includes a radiator and/or a heater core. In other embodiments, the at least one fluid includes sodium silicate, and the heat exchange system includes an engine block and/or a head gasket.

The amount of sodium silicate provided in the at least one fluid in accordance with the present teachings may be varied depending on the particular application. In some embodiments, a “low amount” of sodium silicate is provided. For example, in some embodiments, the sodium silicate comprises from about 3.5 weight percent to about 6 weight percent of the at least one fluid, and the heat exchange system includes an engine block. In other embodiments, a “high amount” of sodium silicate is provided. For example, in some embodiments, the sodium silicate comprises from about 30 weight percent to about 45 weight percent of the at least one fluid, and the heat exchange system includes a head gasket.

The following examples illustrate features in accordance with the present teachings, and are provided solely by way of illustration. They are not intended to limit the scope of the appended claims or their equivalents.

### Examples

### Example 1: Pellet Composition I

| | wt % |
|---|---|
| KWK Bentonite | 46.61 |
| Soybean Meal-3485B | 11.02 |
| Attaclay | 6.36 |
| Soybean Oil | 2.12 |
| Calcium Propionate | 3.81 |
| Citric Acid (Solid) | 12.71 |
| Sodium Bicarbonate | 15.89 |
| Kevlar Pulp (dry) | 1.48 |
| Totals | 100.00 |

The above formulation produces an effervescent sealing pellet composition configured for sealing a fluid leak in a heat exchange system.

### Example 2: Mixture of Fluid with Pellet Composition I

A fluid is mixed with the effervescent pellet composition of Example 1. The mixture produces an effervescent mixture to be added to a heat exchange system. The fluid has the following formulation:

| | wt % |
|---|---|
| ASE 60 | 0.390% |
| Soda Ash | 0.022% |
| Sensient Grey Powder Dye | 0.186% |
| Foam Ban 3529C | 0.046% |
| Selloxize QP5200H | 0.892% |
| Water | 98.464% |
| Totals | 100.00 |

### Example 3: Pellet Composition II

| | wt % |
|---|---|
| KWK Bentonite | 54.51 |
| Soybean Meal-3485B | 12.88 |
| Attaclay | 7.43 |
| Soybean Oil | 2.48 |
| Calcium Propionate | 4.46 |
| Citric Acid (Solid) | 7.14 |
| Sodium Bicarbonate | 9.37 |
| Kevlar Pulp (dry) | 1.73 |
| Totals | 100.00 |

### Example 4: Kit Containing Pellet Composition III

| Ingredient | Wt (g) | Wt % |
|---|---|---|
| First Fluid | 15.0 oz. | |
| Softened Water | 447.47 | 99.926% |
| Acticide LA | 0.22 | 0.049% |
| NaOH, 50% | 0.11 | 0.025% |
| Total | 447.80 | 100.00% |
| Second Fluid | 3.0 oz. | |
| Softened Water | 88.42 | 94.456% |
| Soda Ash | 0.10 | 0.107% |
| ASE 60 | 2.10 | 2.243% |
| Sodium Hydroxide 50% | 0.22 | 0.235% |
| Acticide CBM2 | 0.14 | 0.150% |
| Sag 10 Antifoam | 2.23 | 2.382% |
| Sensient Grey Powder Dye | 0.40 | 0.427% |
| Total | 93.61 | 100.000% |
| Pellet Composition | 68.00 | |
| KWK Bentonite | 35.70 | 52.500% |
| Soybean Meal-3485B | 8.71 | 12.810% |
| Attclay | 4.85 | 7.130% |
| Soy Bean Oil | 1.62 | 2.380% |
| Soy Lecithin | 2.72 | 4.000% |
| Calcium Propionate | 2.91 | 4.280% |
| Citric Acid (Solid) | 4.66 | 6.850% |
| Sodium Bicarbonate | 6.12 | 9.000% |
| Kevlar Pulp (dry) | 0.71 | 1.050% |
| Total | 68.00 | 100.000% |

The first fluid (15 oz.), the second fluid (3 oz.), and the pellet composition (3 oz.) of Example 4 are mixed. The resultant effervescent mixture is added to a heat exchange system (e.g., radiator and heater core).

### Example 5: Kit Containing Pellet Composition IV

| Ingredient | Wt (g) | Wt % |
|---|---|---|
| First Fluid | 15.0 oz. | |
| Softened Water | 433.38 | 95.542% |
| Acticide LA | 0.22 | 0.049% |
| Sodium Silicate (37.5% in | 20.00 | 4.409% |
| water) | | |
| Total | 453.60 | 100.00% |
| Second Fluid | 3.0 oz. | |
| Softened Water | 86.89 | 94.139% |
| Soda Ash | 0.10 | 0.108% |
| ASE 60 | 2.10 | 2.275% |
| Sodium Hydroxide 50% | 0.04 | 0.043% |
| Acticide CBM2 | 0.14 | 0.152% |
| Sag 10 Antifoam | 2.23 | 2.416% |
| Sensient Copper Powder | 0.80 | 0.867% |
| Total | 92.30 | 100.000% |
| Pellet Composition | 68.00 | |
| KWK Bentonite | 35.70 | 52.500% |
| Soybean Meal-3485B | 8.71 | 12.810% |
| Attclay | 4.85 | 7.130% |
| Soy Bean Oil | 1.62 | 2.380% |
| Soy Lecithin | 2.72 | 4.000% |
| Calcium Propionate | 2.91 | 4.280% |
| Citric Acid (Solid) | 4.66 | 6.850% |
| Sodium Bicarbonate | 6.12 | 9.000% |
| Kevlar Pulp (dry) | 0.71 | 1.050% |
| Total | 68.00 | 100.000% |

The first fluid (15 oz.), the second fluid (3 oz.), and the pellet composition (3 oz.) of Example 5 are mixed. The resultant effervescent mixture is added to a heat exchange system (e.g., engine block).

### Example 6: Kit Containing Pellet Composition V

| Ingredient | Wt (g) | Wt % |
|---|---|---|
| First Fluid | 15.0 oz. | |
| Softened Water | 314.44 | 61.092% |
| Acticide LA | 0.26 | 0.051% |
| Sodium Silicate (37.5% in | 200.00 | 38.858% |
| water) | | |
| Total | 514.70 | 100.000% |
| Second Fluid | 3.0 oz. | |
| Softened Water | 88.090 | 94.820% |
| Soda Ash | 0.10 | 0.108% |
| ASE 60 | 2.10 | 2.260% |
| Sodium Hydroxide 50% | 0.04 | 0.043% |
| Acticide CBM2 | 0.14 | 0.151% |
| Sag 10 Antifoam | 2.23 | 2.400% |
| X-3267 Chromatint White 3267 | 0.10 | 0.108% |
| D95160 Chromatint Blue 1873 | 0.10 | 0.110% |
| Total | 92.90 | 100.000% |
| Pellet Composition | 68.00 | |
| KWK Bentonite | 35.70 | 52.500% |
| Soybean Meal-3485B | 8.71 | 12.810% |
| Attclay | 4.85 | 7.130% |
| Soy Bean Oil | 1.62 | 2.380% |
| Soy Lecithin | 2.72 | 4.000% |
| Calcium Propionate | 2.91 | 4.280% |
| Citric Acid (Solid) | 4.66 | 6.850% |
| Sodium Bicarbonate | 6.12 | 9.000% |
| Kevlar Pulp (dry) | 0.71 | 1.050% |
| Total | 68.00 | 100.000% |

The first fluid (15 oz.), the second fluid (3 oz.), and the pellet composition (3 oz.) of Example 6 are mixed. The resultant effervescent mixture is added to a heat exchange system (e.g., head gasket).

### Example 7: Kit Containing Pellet Composition VI

| Ingredient | Wt (g) | Wt % |
|---|---|---|
| First Fluid | 15.0 oz. | |
| Softened Water | 443.44 | 99.975% |
| NaOH, 50% | 0.11 | 0.025% |
| Total | 443.55 | 100.00% |
| Second Fluid | 3.0 oz. | |
| Softened Water | 83.66 | 94.307% |
| Soda Ash | 0.10 | 0.113% |
| ASE 60 | 2.10 | 2.367% |
| Sodium Hydroxide 50% | 0.22 | 0.248% |
| Sag 10 Antifoam | 2.23 | 2.514% |
| Sensient Grey Powder Dye | 0.40 | 0.451% |
| Total | 88.71 | 100% |
| Pellet Composition | 40.36 g | |
| KWK Bentonite | 22.00 | 54.509% |
| Soybean Meal-3485B | 5.20 | 12.884% |
| Attclay | 3.00 | 7.433% |
| Soy Bean Oil | 1.00 | 2.478% |
| Calcium Propionate | 1.80 | 4.460% |
| Citric Acid (Solid) | 2.88 | 7.136% |
| Sodium Bicarbonate | 3.78 | 9.366% |
| Kevlar Pulp (dry) | 0.70 | 1.734% |
| Total | 40.36 | 100.000% |

The first fluid (15 oz.), the second fluid (3 oz.), and the pellet composition (3 oz.) of Example 7 are mixed. The resultant effervescent mixture is added to a heat exchange system (e.g., radiator and heater core).

### Example 8: Kit Containing Pellet Composition VII

| Ingredient | Wt (g) | Wt % |
|---|---|---|
| First Fluid | 15.0 oz. | |
| Softened Water | 426.55 | 95.521% |
| NaOH, 50% | 20.00 | 4.479% |
| Total | 446.55 | 100.00% |
| Second Fluid | 3.0 oz. | |
| Softened Water | 83.44 | 94.059% |
| Soda Ash | 0.10 | 0.113% |
| ASE 60 | 2.10 | 2.367% |
| Sodium Hydroxide 50% | 0.04 | 0.045% |
| Sag 10 Antifoam | 2.23 | 2.514% |
| Sensient Copper Powder | 0.80 | 0.902% |
| Total | 88.71 | 100.000% |
| Pellet Composition | 40.36 g | |
| KWK Bentonite | 22.00 | 54.509% |
| Soybean Meal-3485B | 5.20 | 12.884% |
| Attclay | 3.00 | 7.433% |
| Soy Bean Oil | 1.00 | 2.478% |
| Calcium Propionate | 1.80 | 4.460% |
| Citric Acid (Solid) | 2.88 | 7.136% |
| Sodium Bicarbonate | 3.78 | 9.366% |
| Kevlar Pulp (dry) | 0.70 | 1.734% |
| Total | 40.36 | 100.000% |

The first fluid (15 oz.), the second fluid (3 oz.), and the pellet composition (3 oz.) of Example 8 are mixed. The resultant effervescent mixture is added to a heat exchange system (e.g., engine block).

### Example 9: Kit Containing Pellet Composition VIII

| Ingredient | Wt (g) | Wt % |
|---|---|---|
| First Fluid | 15.0 oz. | |
| Softened Water | 243.55 | 54.909% |
| Sodium Silicate (40% in water) | 200.00 | 45.091% |
| Total | 443.55 | 100.000% |
| Second Fluid | 3.0 oz. | |
| Softened Water | 84.09 | 94.736% |
| Soda Ash | 0.10 | 0.113% |
| ASE 60 | 2.10 | 2.366% |
| Sodium Hydroxide 50% | 0.04 | 0.045% |
| Sag 10 Antifoam | 2.23 | 2.512% |
| X-3267 Chromatint White 3267 | 0.10 | 0.113% |
| D95160 Chromatint Blue 1873 | 0.10 | 0.115% |
| Total | 88.76 | 100.000% |
| Pellet Composition | 40.36 g | |
| KWK Bentonite | 22.00 | 54.509% |
| Soybean Meal-3485B | 5.20 | 12.884% |
| Attclay | 3.00 | 7.433% |
| Soy Bean Oil | 1.00 | 2.478% |
| Calcium Propionate | 1.80 | 4.460% |
| Citric Acid (Solid) | 2.88 | 7.136% |
| Sodium Bicarbonate | 3.78 | 9.366% |
| Kevlar Pulp (dry) | 0.70 | 1.734% |
| Total | 40.36 | 100.000% |

The first fluid (15 oz.), the second fluid (3 oz.), and the pellet composition (3 oz.) of Example 9 are mixed. The resultant effervescent mixture is added to a heat exchange system (e.g., head gasket).

### Example 10: Kit Containing Pellet Composition IX

| Ingredient | Wt (g) | Wt % |
|---|---|---|
| First Fluid | 14.5 oz. | |
| Softened Water | 447.47 | 99.975% |
| NaOH, 50% | 0.11 | 0.025% |
| Total | 447.58 | 100.00% |
| Second Fluid | 2.6 oz. | |
| Softened Water | 88.42 | 94.456% |
| Soda Ash | 0.10 | 0.107% |
| ASE 60 | 2.10 | 2.243% |
| Sodium Hydroxide 50% | 0.22 | 0.235% |
| Acticide CBM2 | 0.14 | 0.150% |
| Sag 10 Antifoam | 2.23 | 2.382% |
| Sensient Grey Powder Dye | 0.40 | 0.427% |
| Total | 93.61 | 100.000% |
| Pellet Composition | 68.00 | |
| KWK Bentonite | 18.02 | 26.500% |
| Soybean Meal-3485B | 36.82 | 54.140% |
| Attclay | 2.06 | 3.030% |
| Soy Bean Oil | 2.17 | 3.190% |
| Soy Lecithin | 1.36 | 2.000% |
| Calcium Propionate | 1.63 | 2.390% |
| Citric Acid (Solid) | 2.33 | 3.425% |
| Sodium Bicarbonate | 3.23 | 4.750% |
| Kevlar Pulp (dry) | 0.39 | 0.575% |
| Total | 68.00 | 100.000% |

The first fluid (14.5 oz.), the second fluid (2.6 oz.), and the pellet composition (75 grams) of Example 10 are mixed. The resultant effervescent mixture is added to a heat exchange system (e.g., radiator and heater core).

### Example 11: Kit Containing Pellet Composition X

| Ingredient | Wt (g) | Wt % |
|---|---|---|
| First Fluid | 14.5 oz. | |
| Softened Water | 433.38 | 95.589% |
| Sodium Silicate (37.5% in water) | 20.00 | 4.411% |
| Total | 453.38 | 100.00% |
| Second Fluid | 2.6 oz. | |
| Softened Water | 86.89 | 94.139% |
| Soda Ash | 0.10 | 0.108% |
| ASE 60 | 2.10 | 2.275% |
| Sodium Hydroxide 50% | 0.04 | 0.043% |
| Acticide CBM2 | 0.14 | 0.152% |
| Sag 10 Antifoam | 2.23 | 2.416% |
| Sensient Copper Powder | 0.80 | 0.867% |
| Total | 92.30 | 100.000% |
| Pellet Composition | 68.00 | |
| KWK Bentonite | 18.02 | 26.500% |
| Soybean Meal-3485B | 36.82 | 54.140% |
| Attclay | 2.06 | 3.030% |
| Soy Bean Oil | 2.17 | 3.190% |
| Soy Lecithin | 1.36 | 2.000% |
| Calcium Propionate | 1.63 | 2.390% |
| Citric Acid (Solid) | 2.33 | 3.425% |
| Sodium Bicarbonate | 3.23 | 4.750% |
| Kevlar Pulp (dry) | 0.39 | 0.575% |
| Total | 68.00 | 100.000% |

The first fluid (14.5 oz.), the second fluid (2.6 oz.), and the pellet composition (75 grams) of Example 11 are mixed. The resultant effervescent mixture is added to a heat exchange system (e.g., engine block).

### Example 12: Kit Containing Pellet Composition XI

| Ingredient | Wt (g) | Wt % |
|---|---|---|
| First Fluid | 14.5 oz. | |
| Softened Water | 314.44 | 61.123% |
| Sodium Silicate (37.5% in water) | 200.00 | 38.877% |
| Total | 514.44 | 100.000% |
| Second Fluid | 2.6 oz. | |
| Softened Water | 88.090 | 94.820% |
| Soda Ash | 0.10 | 0.108% |
| ASE 60 | 2.10 | 2.260% |
| Sodium Hydroxide 50% | 0.04 | 0.043% |
| Acticide CBM2 | 0.14 | 0.151% |
| Sag 10 Antifoam | 2.23 | 2.400% |
| X-3267 Chromatint White 3267 | 0.10 | 0.108% |
| D95160 Chromatint Blue 1873 | 0.10 | 0.110% |
| Total | 92.90 | 100.000% |
| Pellet Composition | 68.00 | |
| KWK Bentonite | 18.02 | 26.500% |
| Soybean Meal-3485B | 36.82 | 54.140% |
| Attclay | 2.06 | 3.030% |
| Soy Bean Oil | 2.17 | 3.190% |
| Soy Lecithin | 1.36 | 2.000% |
| Calcium Propionate | 1.63 | 2.390% |
| Citric Acid (Solid) | 2.33 | 3.425% |
| Sodium Bicarbonate | 3.23 | 4.750% |
| Kevlar Pulp (dry) | 0.39 | 0.575% |
| Total | 68.00 | 100.000% |

The first fluid (14.5 oz.), the second fluid (2.6 oz.), and the pellet composition (75 grams) of Example 12 are mixed. The resultant effervescent mixture is added to a heat exchange system (e.g., head gasket).

As used herein, the phrase “about zero weight percent” refers to amounts of a component that may be above zero. Thus, the phrase “about zero weight percent” may include trace amounts. The phrase “about zero” when used in reference to a given component is not equivalent to “free of” or “lacks.” The terms “free of,” “lacks,” “lacking,” and the like when used in reference to a given component refer to zero weight percent.

In various embodiments, optional components for a sealing composition in accordance with the present teachings are disclosed. When ranges are disclosed for optional components, the ranges are disclosed as “zero to X” weight percent. The “zero” reflects the optionally of the component, and includes an embodiment in which the component is entirely lacking (e.g., lubricant provided in a pellet composition). All ranges disclosed herein with zero as the minimum also include “about zero” as the minimum of the range for the particular component when present. For example, a pellet composition disclosed herein as comprising zero to 5 weight percent of a lubricant includes the range about zero weight percent to 5 weight percent of a lubricant.

It is to be understood that when the qualifying adjective “about” is used only at the start of a list of values (e.g., “about A %, B %, C %, and D %”), the adjective is to be applied to each and every value in the list (e.g., “about A %, about B %, about C %, and about D %”). Similarly, when the adjective “about” is used only at the start of a list of ranges, (e.g., “about A % to B %, C % to D %, E % to F %, and G % to H %”), the adjective is to be applied to each and every endpoint, as well as each and every intermediate value encompassed between the endpoints, within each of the listed ranges (e.g., “about A % to about B %, about C % to about D %, about E % to about F %, and about G % to about H %).

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

1. A kit for sealing a leak, the kit comprising:
a pellet composition and a first fluid configured for combination with the pellet composition;
wherein the pellet composition comprises:
a fibrillated fibrous material;
a particulate material; and
a compound that by itself and/or in combination with at least one additional compound is configured to generate effervescence; and
wherein the first fluid comprises water.

2. The kit of claim 1 wherein the first fluid lacks sodium silicate, and wherein the kit is configured for sealing a leak in a radiator and/or a heater core.

3. The kit of claim 1 wherein the first fluid further comprises sodium silicate.

4. The kit of claim 3 wherein the sodium silicate comprises from about 3 weight percent to about 10 weight percent of the first fluid.

5. The kit of claim 3 wherein the sodium silicate comprises from about 3.5 weight percent to about 6 weight percent of the first fluid, and wherein the kit is configured for sealing a leak in an engine block.

6. The kit of claim 3 wherein the sodium silicate comprises from about 25 weight percent to about 50 weight percent of the first fluid.

7. The kit of claim 3 wherein the sodium silicate comprises from about 30 weight percent to about 45 weight percent of the first fluid, and wherein the kit is configured for sealing a leak in a head gasket.

8. The kit of claim 1 further comprising a second fluid configured for combination with the pellet composition and the first fluid, wherein the second fluid comprises water.

9. The kit of claim 8 wherein the second fluid further comprises an acrylic hardener.

10. The kit of claim 9 wherein the acrylic hardener comprises from about 1 weight percent to about 3 weight percent of the second fluid.

11. The kit of claim 8 wherein the second fluid further comprises a material selected from the group consisting of soda ash, thickeners, sodium hydroxide, biocides, antifoaming agents, cellulosic polymers, copper powder, dyes, and combinations thereof.

12. A method for sealing a leak in a heat exchange system, the method comprising:
combining a pellet composition and at least one fluid to form a mixture; and
introducing the mixture into the heat exchange system;
wherein the pellet composition comprises:
a fibrillated fibrous material;
a particulate material; and
a compound that by itself and/or in combination with at least one additional compound is configured to generate effervescence; and
wherein the at least one fluid comprises water.

13. The method of claim 12 wherein the combining of the pellet composition and the at least one fluid occurs prior to the introducing.

14. The method of claim 12 wherein the at least one fluid lacks sodium silicate, and wherein the heat exchange system comprises a radiator and/or a heater core.

15. The method of claim 12 wherein the at least one fluid comprises sodium silicate, wherein the sodium silicate comprises from about 3.5 weight percent to about 6 weight percent of the at least one fluid, and wherein the heat exchange system comprises an engine block.

16. The method of 12 wherein the at least one fluid comprises sodium silicate, wherein the sodium silicate comprises from about 30 weight percent to about 45 weight percent of the at least one fluid, and wherein the heat exchange system comprises a head gasket.
